(19) United States
(12) Patent Application Publication
(10) Pub. No.: US 2025/0167851 A1
(43) Pub. Date: May 22, 2025

(54) CHANNEL STATE INFORMATION PROCESSING UNIT COUNTING

(71) Applicant: QUALCOMM Incorporated, San Diego, CA (US)

(72) Inventors: Muhammad Sayed Khairy ABDELGHAFFAR, San Jose, CA (US); Yu ZHANG, San Diego, CA (US); Alexandros MANOLAKOS, Athens (GR)

(21) Appl. No.: 18/841,518

(22) PCT Filed: Mar. 29, 2023
(86) PCT No.: PCT/US2023/016733

§ 371 Date: Aug. 26, 2024

(30) Foreign Application Priority Data
Apr. 5, 2022 (GR) 20220100301

(51) Int. Cl. H04B 7/06; H04L 5/00

(52) U.S. Cl. CPC H04B 7/0626; H04L 5/0048

(57) ABSTRACT

Various aspects of the present disclosure generally relate to wireless communication. In some aspects, a user equipment (UE) may obtain a channel state information (CSI) report that is associated with a multi-symbol downlink reference signal and that indicates a report quantity associated with a Doppler shift measurement, a per-path Doppler measurement, or a per-beam-per-path Doppler measurement. The UE may count a number of CSI processing units (CPU's) for processing the CSI report based at least in part on the report quantity. Numerous other aspects are described.

### CROSS-REFERENCE TO RELATED APPLICATION

This Patent Application claims priority to Greece patent application Ser. No. 20220100301, filed on Apr. 5, 2022, entitled “CHANNEL STATE INFORMATION PROCESSING UNIT COUNTING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for channel state information processing unit counting.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support

communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the above-recited features of the present disclosure can be understood in

detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of physical channels and reference signals in a wireless network, in accordance with the present disclosure.

FIGS. 5A and 5B are diagrams illustrating examples of Doppler information reporting, in accordance with the present disclosure.

FIG. 6 is a diagram illustrating an example of a two-slot reference signal for tracking, in accordance with the present disclosure.

FIG. 7 is a diagram illustrating an example associated with channel state information (CSI) processing unit (CPU) counting, in accordance with the present disclosure.

FIG. 8 is a diagram illustrating a first example associated with a timeline for CPU occupation and release, in accordance with the present disclosure.

FIG. 9 is a diagram illustrating a second example associated with a timeline for CPU occupation and release, in accordance with the present disclosure.

FIG. 10 is a diagram illustrating a third example associated with a timeline for CPU occupation and release, in accordance with the present disclosure.

FIG. 11 is a diagram illustrating an example process associated with CPU counting, in accordance with the present disclosure.

FIG. 12 is a diagram of an example apparatus for wireless communication, in accordance with the present disclosure.

### SUMMARY

Some aspects described herein relate to a method of wireless communication performed by a user equipment (UE). The method may include obtaining a channel state information (CSI) report that is associated with a multi-symbol downlink reference signal and that indicates a report quantity associated with a Doppler shift measurement, a per-path Doppler measurement, or a per-beam-per-path Doppler measurement. The method may include counting a number of CSI processing units (CPUs) for processing the CSI report based at least in part on the report quantity.

Some aspects described herein relate to an apparatus for wireless communication performed by a UE. The apparatus may include a memory and one or more processors, coupled to the memory. The one or more processors may be configured to obtain a CSI report that is associated with a multi-symbol downlink reference signal and that indicates a report quantity associated with a Doppler shift measurement, a per-path Doppler measurement, or a per-beam-per-path Doppler measurement. The one or more processors may be configured to count a number of CPUs for processing the CSI report based at least in part on the report quantity.

Some aspects described herein relate to a non-transitory computer-readable medium that stores a set of instructions for wireless communication by a UE. The set of instructions, when executed by one or more processors of the UE, may cause the UE to obtain a CSI report that is associated with a multi-symbol downlink reference signal and that indicates a report quantity associated with a Doppler shift measurement, a per-path Doppler measurement, or a per-beam-per-path Doppler measurement. The set of instructions, when executed by one or more processors of the UE, may cause the UE to count a number of CPUs for processing the CSI report based at least in part on the report quantity.

Some aspects described herein relate to an apparatus for wireless communication. The apparatus may include means for obtaining a CSI report that is associated with a multi-symbol downlink reference signal and that indicates a report quantity associated with a Doppler shift measurement, a per-path Doppler measurement, or a per-beam-per-path Doppler measurement. The apparatus may include means for counting a number of CPUs for processing the CSI report based at least in part on the report quantity.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

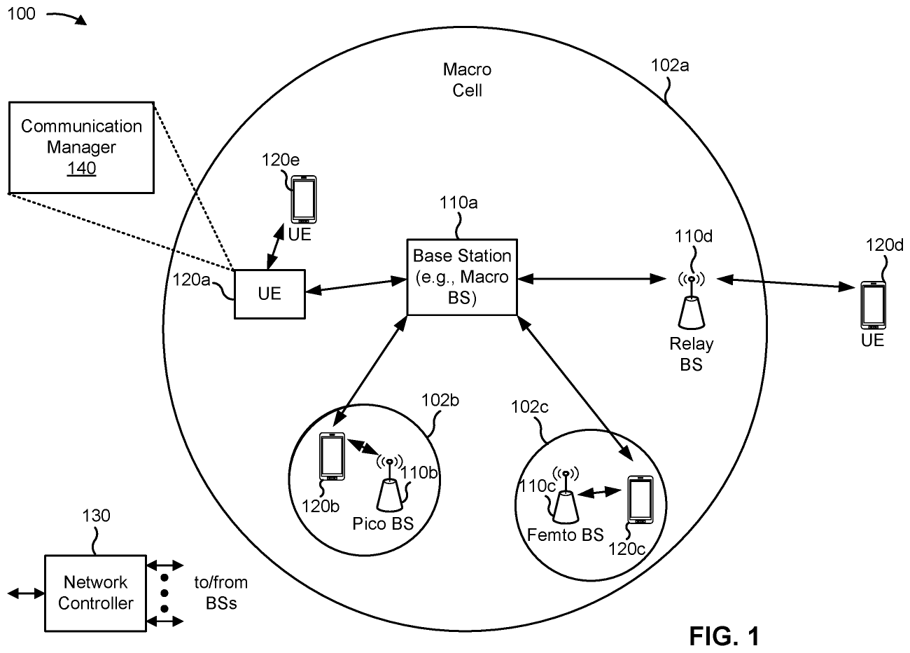

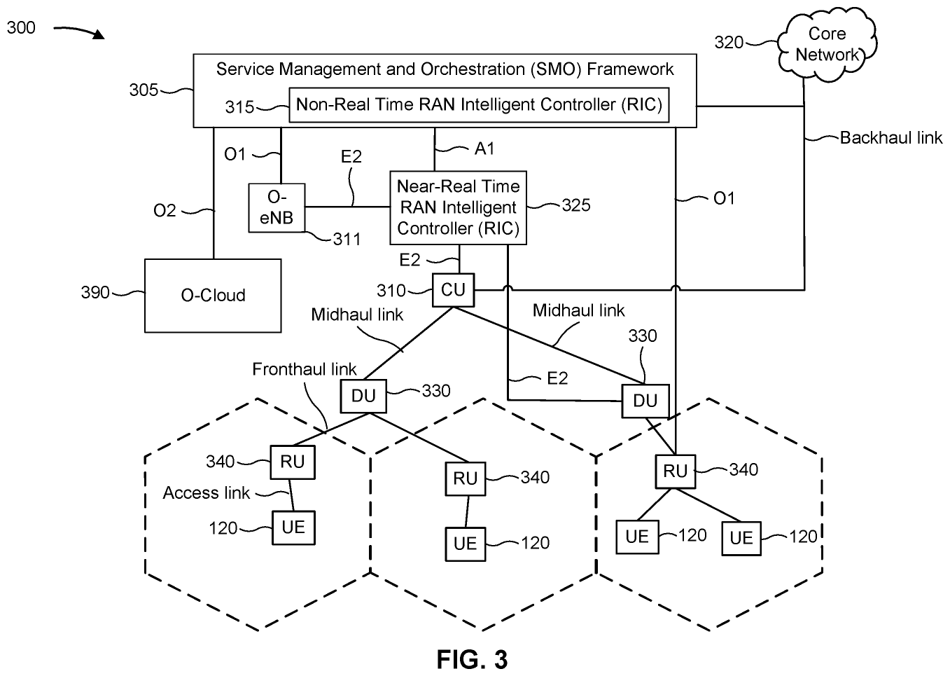

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Moreover, although depicted as an integral unit in FIG. 1, aspects of the disclosure are not so limited. In some other aspects, the functionality of the base station 110 may be disaggregated according to an open radio access network (RAN) (O-RAN) architecture or the like, which is described in more detail in connection with FIG. 3. Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may obtain a channel state information (CSI) report that is associated with a multi-symbol downlink reference signal and that indicates a report quantity associated with a Doppler shift measurement, a per-path Doppler measurement, or a per-beam-per-path Doppler measurement: and count a number of CSI processing units (CPUs) for processing the CSI report based at least in part on the report quantity. Additionally, or alternatively, the communication manager 140 may perform one or more other operations described herein.

As indicated above, FIG. 1 is provided as an example. Other examples may differ from what is described with regard to FIG. 1.

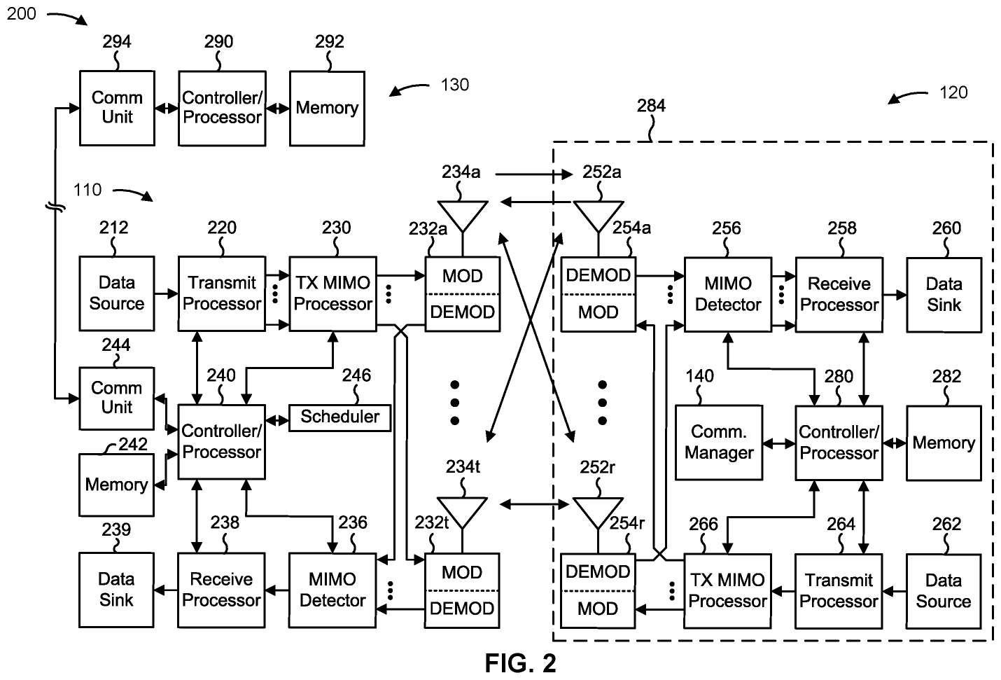

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g. T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

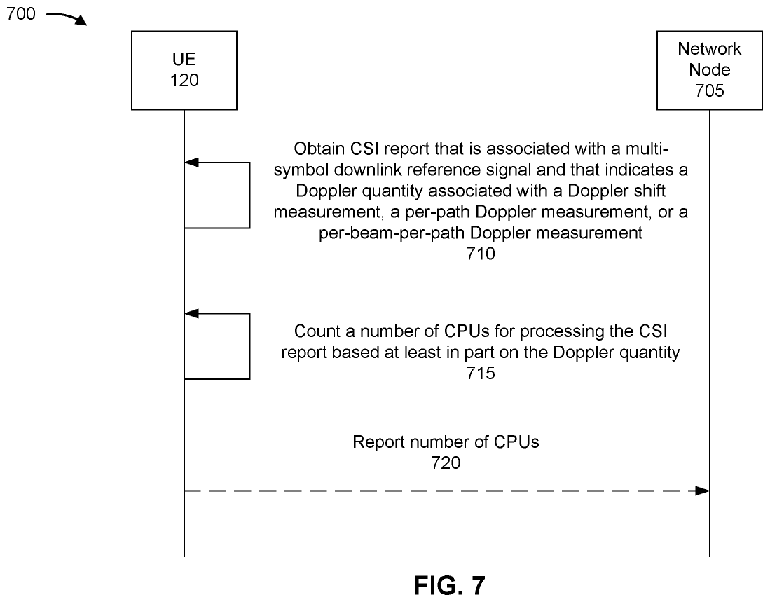

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-12).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-12).

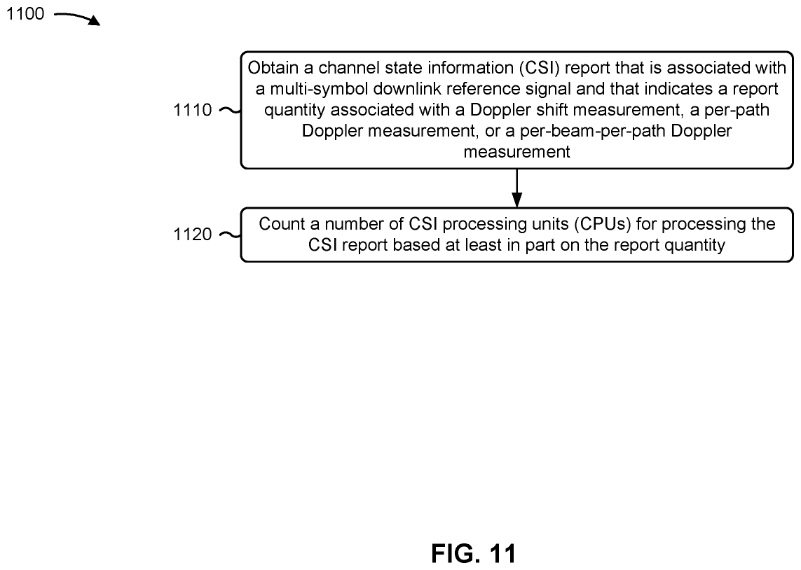

The controller/processor 240 of the base station 110, the controller/processor 280 of the UE 120, and/or any other component(s) of FIG. 2 may perform one or more techniques associated with CPU counting, as described in more detail elsewhere herein. For example, the controller/processor 240 of the base station 110, the controller/processor 280 of the UE 120, and/or any other component(s) of FIG. 2 may perform or direct operations of, for example, process 1100 of FIG. 11, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1100 of FIG. 11, and/or other processes as described herein. In some examples, executing instructions may include running the instructions, converting the instructions, compiling the instructions, and/or interpreting the instructions, among other examples.

In some aspects, a UE (e.g., the UE 120) includes means for obtaining a CSI report that is associated with a multi-symbol downlink reference signal and that indicates a report quantity associated with a Doppler shift measurement, a per-path Doppler measurement, or a per-beam-per-path Doppler measurement: and/or means for counting a number of CPUs for processing the CSI report based at least in part on the report quantity. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 disaggregated base station architecture, in accordance with the present disclosure.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 3 may include one or more CUs 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340), as well as the Near-RT RICs 325. the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the non-RT RIC 315 or the Near-RT RIC 325 may be configured to tune RAN behavior or performance. For example, the non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

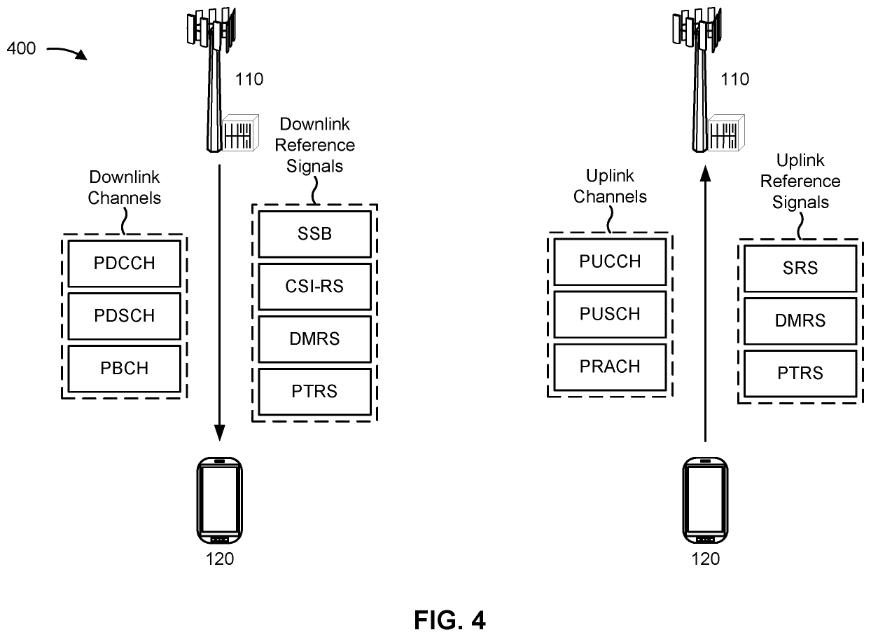

FIG. 4 is a diagram illustrating an example 400 of physical channels and reference signals in a wireless network, in accordance with the present disclosure. As shown in FIG. 4, downlink channels and downlink reference signals may carry information from a base station 110 to a UE 120, and uplink channels and uplink reference signals may carry information from a UE 120 to a base station 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a CSI reference signal (CSI-RS), a demodulation reference signal (DMRS), a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the base station 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The base station 110 may configure a set of CSI-RSs for the UE 120, and the UE 120 may measure the configured set of CSI-RSs. Based at least in part on the measurements, the UE 120 may perform channel estimation and may report channel estimation parameters to the base station 110 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The base station 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the base station 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring base stations in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the base station 110 may then calculate a position of the UE 120 based on the RSTD measurements reported by the UE 120.

An SRS may carry information used for uplink channel estimation, which may be used for scheduling, link adaptation, precoder selection, or beam management, among other examples. The base station 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The base station 110 may measure the SRSs, may perform channel estimation based at least in part on the measurements, and may use the SRS measurements to configure communications with the UE 120.

As indicated above, FIG. 4 is provided as an example. Other examples may differ from what is described with regard to FIG. 4.

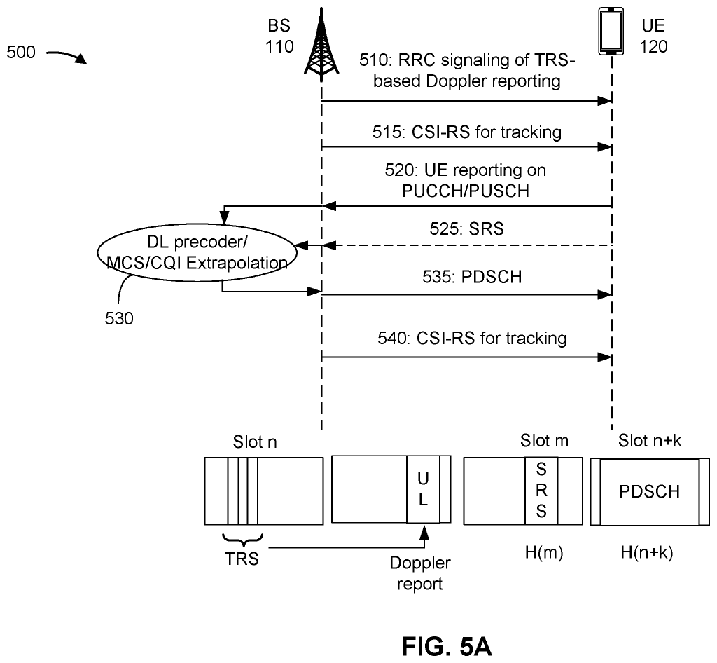

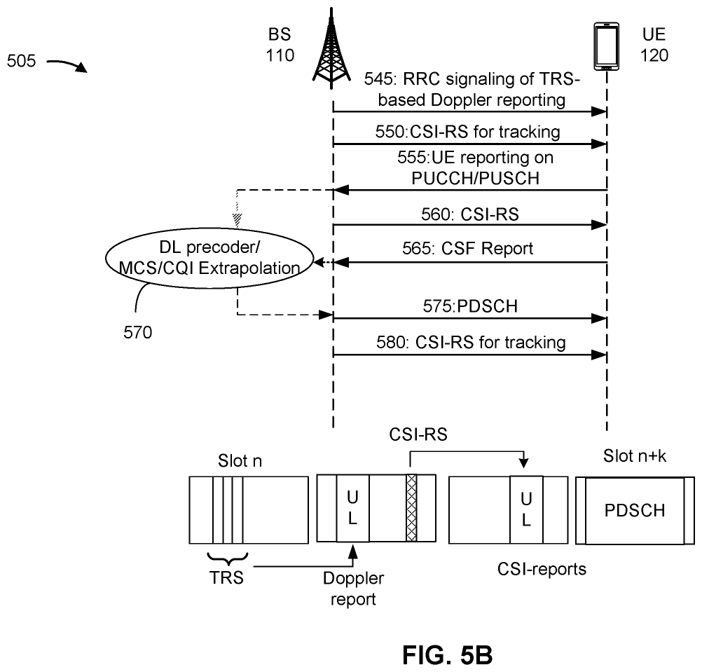

FIGS. 5A and 5B are diagrams illustrating examples 500 and 505, respectively, of Doppler information reporting, in accordance with the present disclosure.

In some cases, as shown in the example 500 of FIG. 5A. Doppler information may be reported using SRS-based reporting. As shown in connection with reference number 510, the base station 110 may transmit, and the UE 120 may receive, RRC signaling for tracking reference signal based (TRS-based) Doppler reporting. As shown in connection with reference number 515, the base station 110 may transmit, and the UE 120 may receive, a first CSI-RS for tracking. As shown in connection with reference number 520, the UE 120 may transmit, and the base station 110 may receive, UE reporting associated with the PUCCH and/or the PUSCH. As shown in connection with reference number 525, the UE 120 may transmit, and the base station 110 may receive, an SRS. As shown in connection with reference number 530, the base station 110 may perform DL precoder, MCS, and/or CQI extrapolation. As shown in connection with reference number 535, the base station 110 may transmit, and the UE 120 may receive, PDSCH information associated with the DL precoder, MCS, and/or CQI extrapolation. As shown in connection with reference number 540, the base station 110 may transmit, and the UE 120 may receive, a second CSI-RS for tracking.

In some cases, as shown in the example 505 of FIG. 5B, the Doppler information may be reported using channel state feedback (CSF) information. As shown in connection with reference number 545, the base station 110 may transmit, and the UE 120 may receive, RRC signaling for TRS-based Doppler reporting. As shown in connection with reference number 550, the base station 110 may transmit, and the UE 120 may receive, a first CSI-RS for tracking. As shown in connection with reference number 555, the UE 120 may transmit, and the base station 110 may receive, UE reporting associated with the PUCCH and/or the PUSCH. As shown in connection with reference number 560, the base station 110 may transmit, and the UE 120 may receive, a CSI-RS. As shown in connection with reference number 565, the UE 120 may transmit, and the base station 110 may receive, a CSF report that is based at least in part on the CSI-RS. As shown in connection with reference number 570, the base station 110 may perform DL precoder, MCS, and/or CQI extrapolation. As shown in connection with reference number 575, the base station 110 may transmit, and the UE 120 may receive, PDSCH information associated with the DL precoder, MCS, and/or CQI extrapolation. As shown in connection with reference number 580, the base station 110 may transmit, and the UE 120 may receive, a second CSI-RS for tracking.

In some cases, the Doppler information may include Doppler shift information, Doppler spread, per-path Doppler information, and/or per-beam-per-path Doppler information.

In some cases, the Doppler shift information may indicate a change to a communication between the UE 120 and the base station 110 resulting from a relative movement between the UE 120 and the base station 110.

In some cases, the per-path Doppler information may indicate the Doppler shifts for M paths, and the time indices for each path, between the UE 120 and the base station 110. In some cases, M may be equal to 1 (M=1) by default. In some cases, the UE 120 may indicate, to the base station 110, the path index of the strongest Doppler measurement (e.g., from a power spectrum perspective). In some cases, the UE 120 may indicate, to the base station 110, the path index of the strongest path Doppler measurement (e.g., from a power path perspective). In some cases, the UE 120 may report a differential Doppler with respect to the mean Doppler or the strongest Doppler.

In some cases, the per-beam-per-path Doppler information may include the per-path Doppler information for a plurality of beams, such as for each beam used for communications between the UE 120 and the base station 110.

In some cases, the UE 120 may report the Doppler shift for the M paths, the time indices for each path, and the relative power for each Doppler measurement. This may be referred to as the per-path Doppler with power reporting.

In some cases, the Doppler information may be included in a report configuration (e.g., CSI-ReportConfig) that is separate from the existing PMI, CQI, CRI, and LI reporting described above (e.g., in FIG. 4).

As indicated above, FIGS. 5A and 5B are provided as an example. Other examples may differ from what is described with regard to FIGS. 5A and 5B.

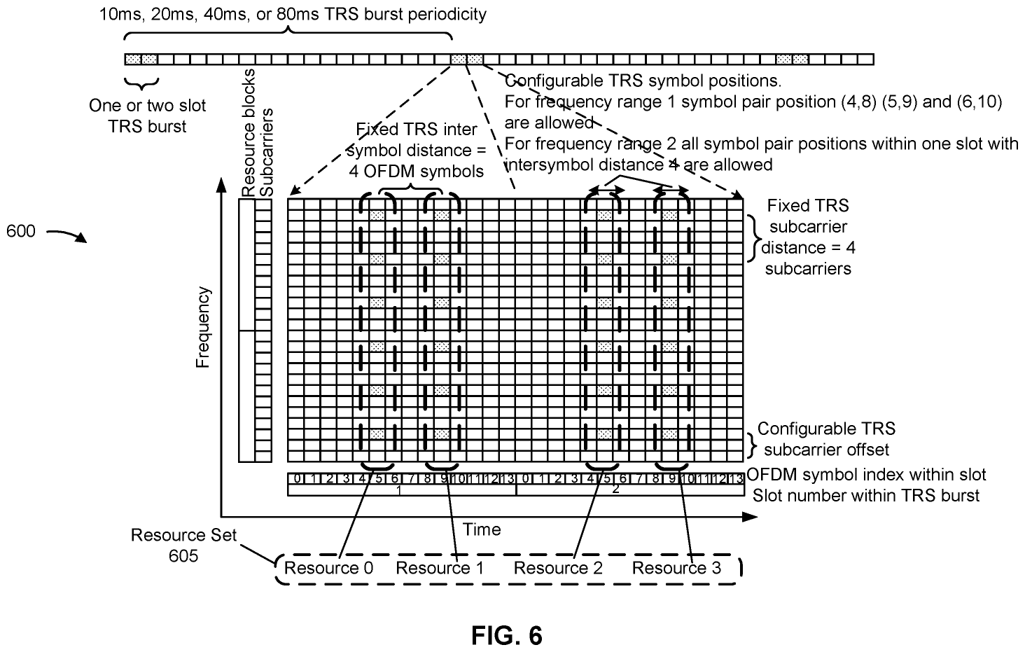

FIG. 6 is a diagram illustrating an example 600 of a two-slot reference signal for tracking, in accordance with the present disclosure.

In some cases, the base station 110 may configure the UE 120 with one or more resource sets, such as a non-zero power CSI-RS (NZP-CSI-RS) resource set (NZP-CSI-RSResourceSet) or a plurality of NZP-CSI-RS resource sets. Each resource set may include one or more CSI-RS resources. In some cases, a single resource set may be configured based at least in part on periodic or semi-persistent scheduling (SPS) triggering being used. In some cases, multiple resource sets may be configured based at least in part on aperiodic triggering being used. The triggering mechanism may be configured within the parameter structure CSI-ResourceConfig. In some cases, the parameter structure used to configure the NZP-CSI-RS resource set may include a resource set identity and a sequence of up to 64 CSI-RS resource identities.

In some cases, the parameter structure may include a flag to indicate whether or not a repetition is enabled. In some cases, if the repetition flag is set to “ON” then all CSI-RSs belonging to the resource set may be transmitted using the same beam (e.g., may be transmitted using the same spatial domain filter). In some cases, the repetition flag may only be set to “ON” when all of the CSI reports linked to the resource set have a report quantity set to either “cri-RSRP” or “none.” In some cases, the “cri-RSRP” value indicates that the UE 120 may report the CSI-RS resource indicator and the RSRP measured from the CSI-RS. In contrast, the “none” value indicates that the UE 120 may not provide the base station 110 with any information regarding the selected beam.

In some cases, the UE 120 in an RRC connected state may receive a UE specific configuration of the NZP-CSI-RS resource set that is configured with a higher layer parameter (trs-Info).

In some cases, for frequency range 1 (FR1) (e.g., 450 MHz to 6 GHz), the UE 120 may be configured with one or more NZP-CSI-RS resource set(s), and the NZP-CSI-RS resource set(s) may include four periodic NZP-CSI-RS resources in two consecutive slots, with two periodic NZP-CSI-RS resources in each slot. In some cases, if no two consecutive slots are indicated as downlink slots, then the UE 120 may be configured with one or more NZP-CSI-RS resource set(s), and the NZP-CSI-RS resource set(s) may include two periodic NZP-CSI-RS resources in one slot.

In some cases, for frequency range 2 (FR2) (e.g., 24.25 GHz to 52.6 GHz), the UE 120 may be configured with one or more NZP-CSI-RS resource set(s), with each NZP-CSI-RS resource set(s) including two periodic CSI-RS resources in one slot, or may be configured with an NZP-CSI-RS resource set having four periodic NZP-CSI-RS resources in two consecutive slots with two periodic NZP-CSI-RS resources in each slot.

As shown in the example 600, the UE 120 may be configured with a resource set 605 or a plurality of resource sets 605. The resource set 605 may be the NZP-CSI-RS resource set. As described above, for FR1 with one or more resource sets 605, or for FR2 with a single resource set 605, each of the resource set(s) 605 may include four periodic NZP-CSI-RS resources in two consecutive slots, and/or may include two periodic NZP-CSI-RS resources in each slot. In some cases, for FR2 with a plurality of resource sets 605, each of the resource sets 605 may include two periodic NZP-CSI-RS resources in one slot.

In some cases, when determining whether to update CSI, the UE 120 may determine a CPU occupancy for a CSI report. The UE 120 may be capable of a number (e.g., a maximum number) of simultaneous CSI calculations, which may be denoted as N_{CPU}. Additionally, or alternatively, the value of N_{CPU} may indicate a number (e.g., a maximum number) of CPUs that the UE 120 is capable of using to process the CSI report across all configured cells. In some aspects, the UE 120 may report the value of N_{CPU} to the base station 110, such as in a UE capability report. If L CPUs of the UE 120 are occupied in a given OFDM symbol, then the UE 120 may have N_{CPU} minus L (N_{CPU}−L) unoccupied CPUs (e.g., CPUs available for performing a CSI calculation and/or processing a CSI report) in the OFDM symbol.

In some cases, an occupied CPU (O_{CPU}) may be based at least in part on the report quantity. For example, O_{OCP}=0 may be indicated for the report quantity “none” and/or for a CSI-RS resource set with the higher layer parameter trs-Info configured. In another example, O_{CPU}=1 may be indicated for the CSI report quantity “cri-RSRP.” “ssb-Index-RSRP,” or “none.” In another example, O_{CPU}=N_{CPU}, where N_{CPU} corresponds to the UE capability for a total number of CPUs, may be indicated for wideband CSI with up to four ports without a CRI report. In another example, O_{CPU}=Kₛ, where Kₛ denotes the number of CSI-RS resources for channel measurement.

In some cases, in any slot, the UE 120 may not be expected to have more active CSI-RS ports or active CSI-RS resources than is reported in the capability information. In some cases, if a CSI-RS resource is associated with N CSI report configurations, the CSI-RS resource, and the ports within the CSI-RS resource, may be counted N times.

In some cases, the CSI report may include Doppler information, such as a Doppler shift measurement, a per-path Doppler measurement, or a per-beam-per-path Doppler measurement. However, the number of CPUs for processing the CSI report may be limited, and the UE 120 may not be able to determine how many CPUs are needed for processing a CSI report that includes the Doppler information. This may result in the UE 120 reserving more CPUs than are needed, or may result in an error if the number of CPUs that are needed to process the CSI report (including the Doppler information) is less than a number of available CPUs.

Techniques and apparatuses are described herein for CPU counting. In some aspects, the UE 120 may obtain a CSI report that is associated with a multi-symbol downlink reference signal and that indicates a report quantity associated with a Doppler shift measurement, a per-path Doppler measurement, or a per-beam-per-path Doppler measurement. The UE 120 may count a number of CPUs for processing the CSI report based at least in part on the report quantity. In some aspects, the number of CPUs may be a fixed number, or may be based at least in part on the number of CSI-RS resources within a TRS burst.

As described herein, the number of CPUs for processing a CSI report may be limited, and the UE 120 may not be able to determine how many CPUs are needed for processing a CSI report that includes Doppler information. Using the techniques and apparatuses described herein, the UE 120 may be able to determine the number of CPUs that are needed for processing the CSI report that includes the Doppler information, thereby reducing a likelihood that too few CPUs are reserved, or that too many CPUs are reserved.

As indicated above, FIG. 6 is provided as an example. Other examples may differ from what is described with regard to FIG. 6.

FIG. 7 is a diagram illustrating an example 700 of CPU counting. The UE 120 may communicate with a network node 705. The network node 705 may include some or all of the features of the base station 110, the CU 310, the DU 330, or the RU 340 described herein.

As shown in connection with reference number 710, the UE 120 may obtain a CSI report that is associated with a multi-symbol downlink reference signal and that indicates a report quantity associated with a Doppler shift measurement, a per-path Doppler measurement, or a per-beam-per-path Doppler measurement. The Doppler measurements may refer to a Doppler shift and/or maximum Doppler spread frequency. In some aspects, the multi-symbol downlink reference signal may be a TRS.

In some aspects, the CSI report may indicate a report quantity associated with the Doppler shift measurement or other Doppler shift information. In some aspects, the CSI report may indicate a report quantity associated with the per-path Doppler measurement or other per-path Doppler information. In some aspects, the CSI report may indicate a report quantity associated with the per-beam-per-path Doppler measurement or other per-beam-per-path Doppler information. In some aspects, the CSI report may indicate a report quantity associated with two or more of the Doppler shift measurement, the per-path Doppler measurement, or the per-beam-per-path Doppler measurement.

As shown in connection with reference number 715, the UE 120 may count a number of CPUs that are needed for processing the CSI report based at least in part on the report quantity.

In some aspects, the CPU counting may be based at least in part on a fixed number. For example, the number of CPUs may be equal to one (O_{CPU}=1) or may be equal to two (O_{CPU}=2).

In some aspects, the fixed number may be based at least in part on a configured quantity. For example, the UE 120 may determine a value of one for a Doppler shift, a value of X for a per-path Doppler, or a value of (X*Y) or (X+1) for the per-beam-per-path Doppler, where X is a number of paths and Y is a number of beams.

In some aspects, the fixed number may be based at least in part on a configured number of Doppler values N reported for each path or for each beam. For example, the UE 120 may determine a value of one for the Doppler shift, a value of N*X for the per-path Doppler, or a value of N(X*Y) or N(X+Y) for the per-beam-per-path Doppler. In some aspects, the number of CPUs may be based at least in part on the configured quantity and the number of Doppler frequencies reported per configured quantity.

In some aspects, the CPU counting may be different depending on whether only Doppler shift is reported or whether per-path Doppler or per-beam-per-path Doppler is reported. For example, the Doppler shift may not require any (e.g., may require zero) CPUs, while the per-path Doppler may require one or more (e.g., X) CPUs.

In some aspects, the number of CPUs may be based at least in part on the number of CSI-RS resources within a TRS burst.

In some aspects, the multi-symbol downlink reference signal may be the CSI-RS that is used for tracking, or may be a multi-symbol PRS or generic reference signal that is used for sensing.

In some aspects, the UE 120 may be configured to determine an occupation time or a release time for one or more of the CPUs. In some aspects, for a periodic CSI report or an SPS CSI report, the CPU(s) may become occupied at the first CSI-RS within the latest TRS burst that is before the CSI-RS reference resource. In some aspects, for an aperiodic CSI report, the CPU(s) may become occupied at an end of a last symbol of the PDCCH carrying the CSI triggered.

In some aspects, when multiple TRS bursts are expected to be measured, the CPU(s) may become occupied at the CSI-RS within the latest TRS before the reference resource. In some aspects, the CPU(s) may be released at an end of a last symbol of the PUCCH or PUSCH carrying the CSI report.

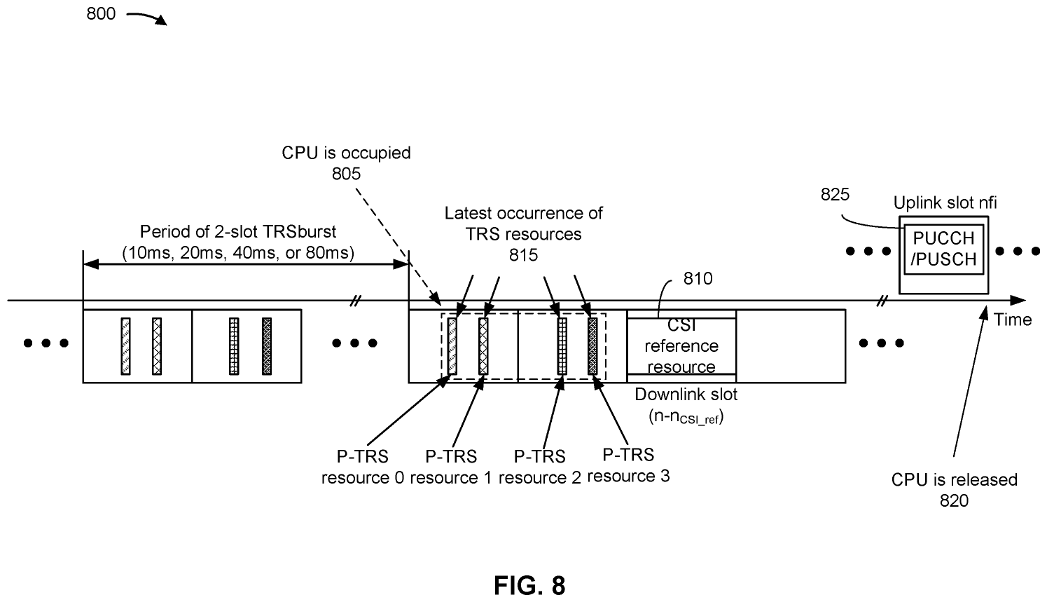

Additional details regarding the timeline CPU occupation and release are described in connection with FIG. 8.

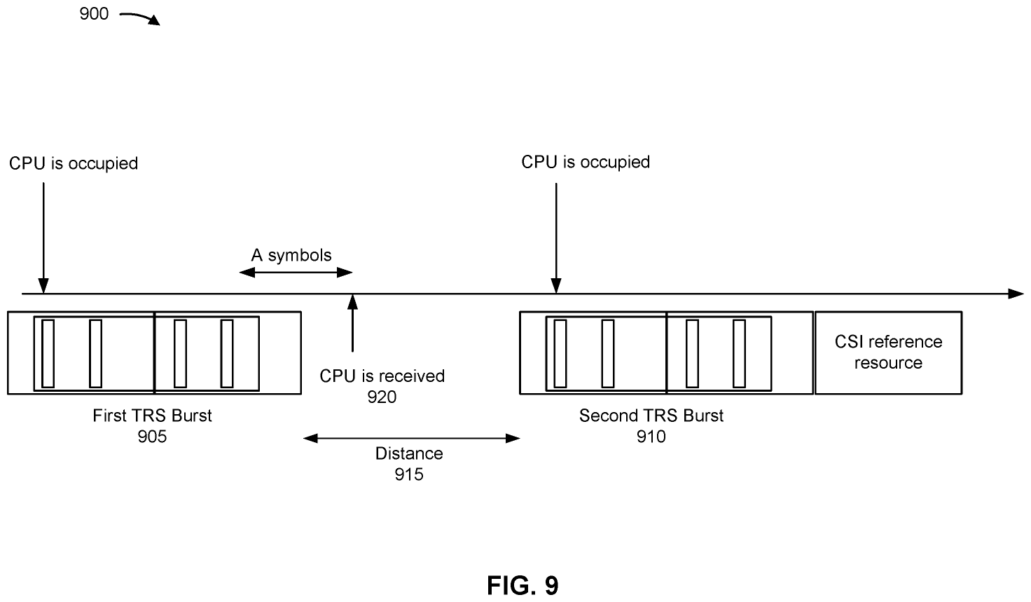

In some aspects, a first TRS may be greater than, or greater than or equal to, a threshold distance from a second TRS. In this case, the CPU(s) may be temporarily released between the first TRS and the second TRS. For example, the CPU may start at a first CSI-RS up to A slots or symbols after the last CSI-RS of the first TRS burst. When the second TRS burst begins, the CPU(s) may be assumed to be occupied again. Additional details regarding these features are described in connection with FIG. 9.

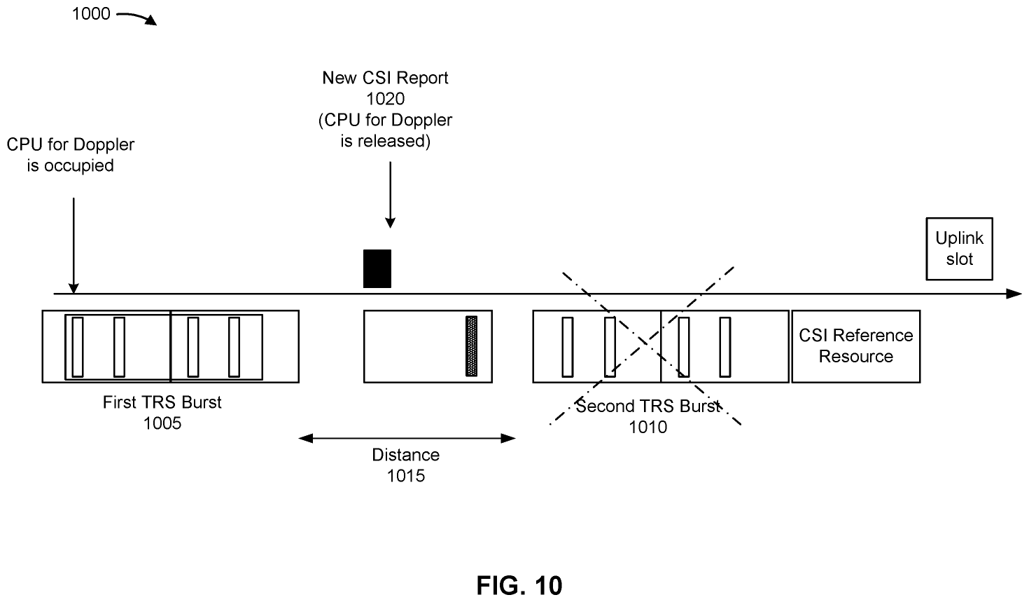

In some aspects, when the first TRS is greater than the threshold distance from the second TRS, and when there is a new CSI report triggered in between the first TRS and the second TRS, the CPU(s) of the Doppler measurements may be reserved for the on-going Doppler measurements and averaging. In this case, the CPU(s) may not be released. In some aspects, if the CPU(s) of the triggered CSI report exceed the limit of the maximum CPU count, the UE 120 may drop the Doppler measurements of a next TRS burst to free-up the CPU(s) for the newly triggered CSI report. Additional details regarding these features are described in connection with FIG. 10.

In some aspects, the UE 120 may be configured to perform CSI-RS resource counting.

In some aspects, when the UE 120 is configured to report Doppler measurements based at least in part on the multi-symbol downlink reference signal, the number of CSI-RS resources per TRS burst (TRS resource set) may be counted toward the limit of the maximum number of active CSI-RS resources. In some aspects, the number of CSI-RS resources may be counted as B, where B is the number of CSI-RS resources for tracking within the TRS burst. In some aspects, the number of CSI-RS resources may be counted as one CSI-RS resource. For example, all of the CSI-RS resources may be counted as a single CSI-RS resource.

In some aspects, when the UE 120 is configured to report Doppler measurements based at least in part on the multi-symbol downlink reference signal, the number of ports may be counted toward the maximum number of ports in the active CSI-RS resources. In some aspects, the number of ports may be counted as C, where C is the number of CSI-RS resources per TRS burst. In some aspects, the number of ports may be counted as one port. For example, all of the ports may be counted as a single port.

As shown in connection with reference number 720, the UE 120 may report the number of CPUs. For example, the UE 120 may transmit, and the base station 110 may receive, an indication of the number of CPUs that are needed for processing the CSI report that includes the Doppler information.

As described above, the number of CPUs for processing a CSI report may be limited, and the UE 120 may not be able to determine how many CPUs are needed for processing a CSI report that includes Doppler information. Using the techniques and apparatuses described herein, the UE 120 may be able to determine the number of CPUs that are needed for processing the CSI report that includes the Doppler information, thereby reducing a likelihood that too few CPUs are reserved, or that too many CPUs are reserved.

As indicated above, FIG. 7 is provided as an example. Other examples may differ from what is described with regard to FIG. 7.

FIG. 8 is a diagram illustrating a first example 800 of a timeline for CPU occupation and release, in accordance with the present disclosure.

In some aspects (as described above in connection with FIG. 7), the UE 120 may be configured to determine an occupation time or a release time for one or more of the CPUs.

In some aspects, for the periodic CSI report or the SPS CSI report, the CPU(s) may become occupied at the first CSI-RS within the latest TRS burst that is before the CSI-RS reference resource. For example, the CPU(s) may become occupied at the location corresponding to reference number 805 (e.g., CPU is occupied 805) that is within the latest TRS burst before the CSI reference resource 810. In some aspects, for the aperiodic CSI report, the CPU(s) may become occupied at an end of a last symbol of the PDCCH carrying the CSI.

In some aspects, when multiple TRS bursts are expected to be measured, the CPU(s) may become occupied at the CSI-RS within the latest TRS before the CSI reference resource 810. For example, the CPU(s) may become occupied at the location corresponding to reference number 815 (e.g., the latest occurrence of TRS resources 815) before the CSI reference resource 810.

In some aspects, the CPU(s) may be released at the end of the last symbol of the PUCCH or PUSCH carrying the CSI report. For example, the CPU(s) may be released at the location corresponding to reference number 820 (e.g., CPU is released 820) that is at the end of the last symbol of the PUCCH/PUSCH 825 that is carrying the CSI report.

As indicated above, FIG. 8 is provided as an example. Other examples may differ from what is described with regard to FIG. 8.

FIG. 9 is a diagram illustrating a second example 900 of a timeline for CPU occupation and release, in accordance with the present disclosure.

In some aspects, a first TRS may be greater than, or greater than or equal to, a threshold distance from a second TRS. For example, the first TRS burst 905 and the second TRS burst 910 may be greater than the distance 915 (e.g., the threshold distance) apart. In this case, the CPU(s) may be temporarily released between the first TRS burst 905 and the second TRS burst 910. For example, the CPU may be received at the location corresponding to reference number 920 (CPU is received 920) that is at a first CSI-RS up to A slots or symbols after the last CSI-RS of the first TRS burst 905. In some aspects, when the second TRS burst 910 begins, the CPU(s) may be assumed to be occupied again.

As indicated above, FIG. 9 is provided as an example. Other examples may differ from what is described with regard to FIG. 9.

FIG. 10 is a diagram illustrating an example 1000 of a timeline for CPU occupation and release, in accordance with the present disclosure.

In some aspects, the first TRS burst 1005 may be greater than the threshold distance (e.g., the distance 1015) from the second TRS burst 1010, and there may be a new CSI report 1020 triggered between the first TRS burst 1005 and the second TRS burst 1010. In some aspects, if the CPU(s) of the new CSI report 1020 exceed the limit of the maximum CPU count, the UE 120 may drop or release the Doppler measurements of the second TRS burst 1010 to free-up the CPU(s) for the newly triggered CSI report 1020.

As indicated above, FIG. 10 is provided as an example. Other examples may differ from what is described with regard to FIG. 10.

FIG. 11 is a diagram illustrating an example process 1100 performed, for example, by a UE, in accordance with the present disclosure. Example process 1100 is an example where the UE (e.g., UE 120) performs operations associated with CPU counting.

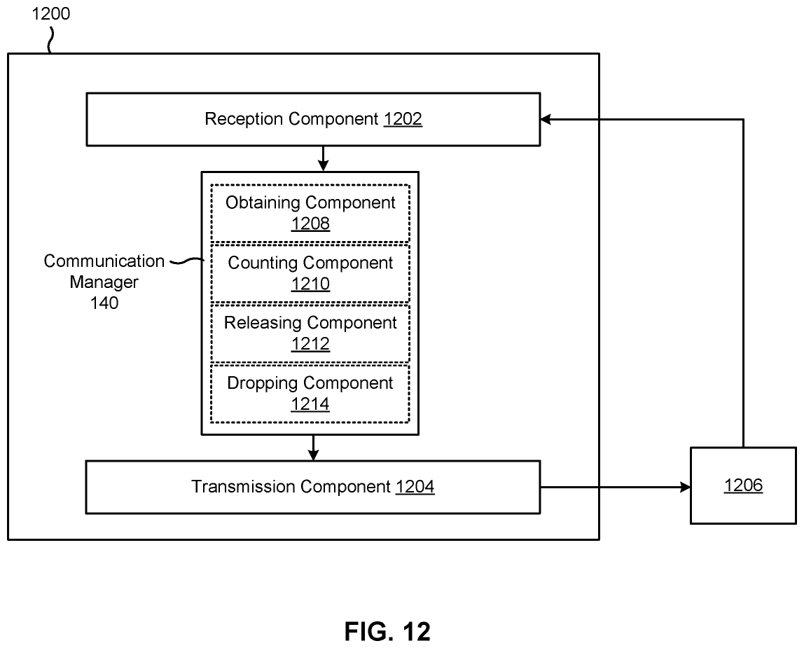

As shown in FIG. 11, in some aspects, process 1100 may include obtaining a CSI report that is associated with a multi-symbol downlink reference signal and that indicates a report quantity associated with a Doppler shift measurement, a per-path Doppler measurement, or a per-beam-per-path Doppler measurement (block 1110). For example, the UE (e.g., using communication manager 140 and/or obtaining component 1208, depicted in FIG. 12) may obtain a CSI report that is associated with a multi-symbol downlink reference signal and that indicates a report quantity associated with a Doppler shift measurement, a per-path Doppler measurement, or a per-beam-per-path Doppler measurement, as described above.

As further shown in FIG. 11, in some aspects, process 1100 may include counting a number of CPUs for processing the CSI report based at least in part on the report quantity (block 1120). For example, the UE (e.g., using communication manager 140 and/or counting component 1210, depicted in FIG. 12) may count a number of CPUs for processing the CSI report based at least in part on the report quantity, as described above.

Process 1100 may include additional aspects, such as any single aspect or any combination of aspects described below and/or in connection with one or more other processes described elsewhere herein.

In a first aspect, the number of CPUs is a fixed number.

In a second aspect, alone or in combination with the first aspect, the fixed number is based at least in part on a number of paths associated with the per-path Doppler measurement.

In a third aspect, alone or in combination with one or more of the first and second aspects, the fixed number is based at least in part on a number of paths, a number of beams, or the number of paths and the number of beams associated with the per-beam-per-path Doppler measurement.

In a fourth aspect, alone or in combination with one or more of the first through third aspects, the fixed number is based at least in part on a number of Doppler values associated with the per-path Doppler measurement or the per-beam-per-path Doppler measurement.

In a fifth aspect, alone or in combination with one or more of the first through fourth aspects, the number of Doppler values is a number of Doppler frequencies associated with the per-path Doppler measurement or the per-beam-per-path Doppler measurement.

In a sixth aspect, alone or in combination with one or more of the first through fifth aspects, counting the number of CPUs comprises using a first counting process if the report quantity is associated with the Doppler shift measurement or a second counting process if the report quantity is associated with the per-path Doppler measurement or the per-beam-per-path Doppler measurement.

In a seventh aspect, alone or in combination with one or more of the first through sixth aspects, counting the number of CPUs comprises counting a number of CSI reference signal resources within a tracking reference signal burst.

In an eighth aspect, alone or in combination with one or more of the first through seventh aspects, the multi-symbol downlink reference signal is a generic reference signal, a positioning reference signal, a tracking reference signal, a radar reference signal, or a CSI reference signal.

In a ninth aspect, alone or in combination with one or more of the first through eighth aspects, the CSI report is a periodic CSI report or a semi-persistent CSI report.

In a tenth aspect, alone or in combination with one or more of the first through ninth aspects, counting the number of CPUs comprises counting the number of CPUs based at least in part on the number of CPUs becoming occupied at a first CSI reference signal that is located in a last tracking reference signal burst prior to a CSI reference resource.

In an eleventh aspect, alone or in combination with one or more of the first through tenth aspects, the CSI report is an aperiodic CSI report.

In a twelfth aspect, alone or in combination with one or more of the first through eleventh aspects, counting the number of CPUs comprises counting the number of CPUs based at least in part on the number of CPUs becoming occupied at an end of a last symbol of a physical downlink control channel carrying a CSI reference signal associated with the CSI report.

In a thirteenth aspect, alone or in combination with one or more of the first through twelfth aspects, process 1100 includes releasing one or more CPUs of the number of CPUs at an end of a last symbol of a physical uplink control channel or physical uplink shared channel carrying the CSI report.

In a fourteenth aspect, alone or in combination with one or more of the first through thirteenth aspects, process 1100 includes releasing one or more CPUs of the number of CPUs between a first TRS burst and a second TRS burst based at least in part on the first TRS burst and the second TRS burst being greater than a threshold distance apart.

In a fifteenth aspect, alone or in combination with one or more of the first through fourteenth aspects, the threshold distance is based at least in part on a number of slots or a number of symbols.

In a sixteenth aspect, alone or in combination with one or more of the first through fifteenth aspects, the first TRS burst and the second TRS burst are greater than the threshold distance apart, and another CSI report is obtained after the first TRS burst and prior to the second TRS burst.

In a seventeenth aspect, alone or in combination with one or more of the first through sixteenth aspects, one or more CPUs of the number of CPUs are reserved for additional Doppler measurements and averaging.

In an eighteenth aspect, alone or in combination with one or more of the first through seventeenth aspects, process 1100 includes dropping one or more Doppler measurements of a third TRS burst based at least in part on one or more CPUs associated with the other CSI report exceeding a maximum CPU count.

In a nineteenth aspect, alone or in combination with one or more of the first through eighteenth aspects, process 1100 includes counting a number of CSI reference signal resources for a TRS resource set toward a maximum number of active CSI reference signal resources.

In a twentieth aspect, alone or in combination with one or more of the first through nineteenth aspects, counting the number of CSI reference signal resources comprises counting each CSI reference signal resource within the TRS resource set.

In a twenty-first aspect, alone or in combination with one or more of the first through twentieth aspects, counting the number of CSI reference signal resources comprises counting all of the CSI reference signal resources within the TRS resource set as a single CSI reference signal resource.

In a twenty-second aspect, alone or in combination with one or more of the first through twenty-first aspects, process 1100 includes counting a number of ports for a TRS resource set toward a maximum number of ports.

In a twenty-third aspect, alone or in combination with one or more of the first through twenty-second aspects, counting the number of ports comprises counting each port within the TRS resource set.

In a twenty-fourth aspect, alone or in combination with one or more of the first through twenty-third aspects, counting the number of ports comprises counting all of the ports within the TRS resource set as a single port.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 140. The communication manager 140 may include one or more of an obtaining component 1208, a counting component 1210, a releasing component 1212, or a dropping component 1214, among other examples.

In some aspects, the apparatus 1200 may be configured to perform one or more operations described herein in connection with FIGS. 7-10. Additionally, or alternatively, the apparatus 1200 may be configured to perform one or more processes described herein, such as process 1100 of FIG. 11. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The obtaining component 1208 may obtain a CSI report that is associated with a multi-symbol downlink reference signal and that indicates a report quantity associated with a Doppler shift measurement, a per-path Doppler measurement, or a per-beam-per-path Doppler measurement. The counting component 1210 may count a number of CPUs for processing the CSI report based at least in part on the report quantity.

The releasing component 1212 may release one or more CPUs of the number of CPUs at an end of a last symbol of a physical uplink control channel or physical uplink shared channel carrying the CSI report.

The releasing component 1212 may release one or more CPUs of the number of CPUs between a first TRS burst and a second TRS burst based at least in part on the first TRS burst and the second TRS burst being greater than a threshold distance apart.

The dropping component 1214 may drop one or more Doppler measurements of a third TRS burst based at least in part on one or more CPUs associated with the other CSI report exceeding a maximum CPU count.

The counting component 1210 may count a number of CSI reference signal resources for a TRS resource set toward a maximum number of active CSI reference signal resources.

The counting component 1210 may count a number of ports for a TRS resource set toward a maximum number of ports.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:
Aspect 1: A method of wireless communication performed by a user equipment (UE), comprising: obtaining a channel state information (CSI) report that is associated with a multi-symbol downlink reference signal and that indicates a report quantity associated with a Doppler shift measurement, a per-path Doppler measurement, or a per-beam-per-path Doppler measurement; and counting a number of CSI processing units (CPUs) for processing the CSI report based at least in part on the report quantity.
Aspect 2: The method of Aspect 1, wherein the number of CPUs is a fixed number.
Aspect 3: The method of Aspect 2, wherein the fixed number is based at least in part on a number of paths associated with the per-path Doppler measurement.
Aspect 4: The method of Aspect 2, wherein the fixed number is based at least in part on a number of paths, a number of beams, or the number of paths and the number of beams associated with the per-beam-per-path Doppler measurement.
Aspect 5: The method of Aspect 2, wherein the fixed number is based at least in part on a number of Doppler values associated with the per-path Doppler measurement or the per-beam-per-path Doppler measurement.
Aspect 6: The method of Aspect 5, wherein the number of Doppler values is a number of Doppler frequencies associated with the per-path Doppler measurement or the per-beam-per-path Doppler measurement.
Aspect 7: The method of any of Aspects 1-6, wherein counting the number of CPUs comprises using a first counting process if the report quantity is associated with the Doppler shift measurement or a second counting process if the report quantity is associated with the per-path Doppler measurement or the per-beam-per-path Doppler measurement.
Aspect 8: The method of any of Aspects 1-7, wherein counting the number of CPUs comprises counting a number of CSI reference signal resources within a tracking reference signal burst.
Aspect 9: The method of any of Aspects 1-8, wherein the multi-symbol downlink reference signal is a generic reference signal, a positioning reference signal, a tracking reference signal, a radar reference signal, or a CSI reference signal.
Aspect 10: The method of any of Aspects 1-9, wherein the CSI report is a periodic CSI report or a semi-persistent CSI report.
Aspect 11: The method of Aspect 10, wherein counting the number of CPUs comprises: counting the number of CPUs based at least in part on the number of CPUs becoming occupied at a first CSI reference signal that is located in a last tracking reference signal burst prior to a CSI reference resource.
Aspect 12: The method of any of Aspects 1-11, wherein the CSI report is an aperiodic CSI report.
Aspect 13: The method of Aspect 12, wherein counting the number of CPUs comprises: counting the number of CPUs based at least in part on the number of CPUs becoming occupied at an end of a last symbol of a physical downlink control channel carrying a CSI reference signal associated with the CSI report.
Aspect 14: The method of any of Aspects 1-13, further comprising releasing one or more CPUs of the number of CPUs at an end of a last symbol of a physical uplink control channel or physical uplink shared channel carrying the CSI report.
Aspect 15: The method of any of Aspects 1-14, further comprising releasing one or more CPUs of the number of CPUs between a first tracking reference signal (TRS) burst and a second TRS burst based at least in part on the first TRS burst and the second TRS burst being greater than a threshold distance apart.
Aspect 16: The method of Aspect 15, wherein the threshold distance is based at least in part on a number of slots or a number of symbols.
Aspect 17: The method of Aspect 15, wherein the first TRS burst and the second TRS burst are greater than the threshold distance apart, and wherein another CSI report is obtained after the first TRS burst and prior to the second TRS burst.
Aspect 18: The method of Aspect 17, wherein one or more CPUs of the number of CPUs are reserved for additional Doppler measurements and averaging.
Aspect 19: The method of Aspect 17, further comprising dropping one or more Doppler measurements of a third TRS burst based at least in part on one or more CPUs associated with the other CSI report exceeding a maximum CPU count.
Aspect 20: The method of any of Aspects 1-19, further comprising counting a number of CSI reference signal resources for a tracking reference signal (TRS) resource set toward a maximum number of active CSI reference signal resources.
Aspect 21: The method of Aspect 20, wherein counting the number of CSI reference signal resources comprises counting each CSI reference signal resource within the TRS resource set.
Aspect 22: The method of Aspect 20, wherein counting the number of CSI reference signal resources comprises counting all of the CSI reference signal resources within the TRS resource set as a single CSI reference signal resource.
Aspect 23: The method of any of Aspects 1-22, further comprising counting a number of ports for a tracking reference signal (TRS) resource set toward a maximum number of ports.
Aspect 24: The method of Aspect 23, wherein counting the number of ports comprises counting each port within the TRS resource set.
Aspect 25: The method of Aspect 23, wherein counting the number of ports comprises counting all of the ports within the TRS resource set as a single port.
Aspect 26: An apparatus for wireless communication at a device, comprising a processor: memory coupled with the processor; and instructions stored in the memory and executable by the processor to cause the apparatus to perform the method of one or more of Aspects 1-25.
Aspect 27: A device for wireless communication, comprising a memory and one or more processors coupled to the memory, the one or more processors configured to perform the method of one or more of Aspects 1-25.
Aspect 28: An apparatus for wireless communication, comprising at least one means for performing the method of one or more of Aspects 1-25.
Aspect 29: A non-transitory computer-readable medium storing code for wireless communication, the code comprising instructions executable by a processor to perform the method of one or more of Aspects 1-25.
Aspect 30: A non-transitory computer-readable medium storing a set of instructions for wireless communication, the set of instructions comprising one or more instructions that, when executed by one or more processors of a device, cause the device to perform the method of one or more of Aspects 1-25.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
obtain a channel state information (CSI) report that is associated with a multi-symbol downlink reference signal and that indicates a report quantity associated with a Doppler shift measurement, a per-path Doppler measurement, or a per-beam-per-path Doppler measurement; and
count a number of CSI processing units (CPUs) for processing the CSI report based at least in part on the report quantity.

2. The apparatus of claim 1, wherein the number of CPUs is a fixed number.

3. The apparatus of claim 2, wherein the fixed number is based at least in part on a number of paths associated with the per-path Doppler measurement.

4. The apparatus of claim 2, wherein the fixed number is based at least in part on a number of paths, a number of beams, or the number of paths and the number of beams associated with the per-beam-per-path Doppler measurement.

5. The apparatus of claim 2, wherein the fixed number is based at least in part on a number of Doppler values associated with the per-path Doppler measurement or the per-beam-per-path Doppler measurement.

6. The apparatus of claim 5, wherein the number of Doppler values is a number of Doppler frequencies associated with the per-path Doppler measurement or the per-beam-per-path Doppler measurement.

7. The apparatus of claim 1, wherein the one or more processors, to count the number of CPUs, are configured to use a first counting process if the report quantity is associated with the Doppler shift measurement or a second counting process if the report quantity is associated with the per-path Doppler measurement or the per-beam-per-path Doppler measurement.

8. The apparatus of claim 1, wherein the one or more processors, to count the number of CPUs, are configured to count a number of CSI reference signal resources within a tracking reference signal burst.

9. The apparatus of claim 1, wherein the multi-symbol downlink reference signal is a generic reference signal, a positioning reference signal, a tracking reference signal, a radar reference signal, or a CSI reference signal.

10. The apparatus of claim 1, wherein the CSI report is a periodic CSI report or a semi-persistent CSI report.

11. The apparatus of claim 10, wherein the one or more processors, to count the number of CPUs, are configured to:
count the number of CPUs based at least in part on the number of CPUs becoming occupied at a first CSI reference signal that is located in a last tracking reference signal burst prior to a CSI reference resource.

12. The apparatus of claim 1, wherein the CSI report is an aperiodic CSI report.

13. The apparatus of claim 12, wherein the one or more processors, to count the number of CPUs, are configured to:
count the number of CPUs based at least in part on the number of CPUs becoming occupied at an end of a last symbol of a physical downlink control channel carrying a CSI reference signal associated with the CSI report.

14. The apparatus of claim 1, wherein the one or more processors are further configured to release one or more CPUs of the number of CPUs at an end of a last symbol of a physical uplink control channel or physical uplink shared channel carrying the CSI report.

15. The apparatus of claim 1, wherein the one or more processors are further configured to release one or more CPUs of the number of CPUs between a first tracking reference signal (TRS) burst and a second TRS burst based at least in part on the first TRS burst and the second TRS burst being greater than a threshold distance apart.

16. The apparatus of claim 15, wherein the threshold distance is based at least in part on a number of slots or a number of symbols.

17. The apparatus of claim 15, wherein the first TRS burst and the second TRS burst are greater than the threshold distance apart, and wherein another CSI report is obtained after the first TRS burst and prior to the second TRS burst.

18. The apparatus of claim 17, wherein one or more CPUs of the number of CPUs are reserved for additional Doppler measurements and averaging.

19. The apparatus of claim 17, wherein the one or more processors are further configured to drop one or more Doppler measurements of a third TRS burst based at least in part on one or more CPUs associated with the other CSI report exceeding a maximum CPU count.

20. The apparatus of claim 1, wherein the one or more processors are further configured to count a number of CSI reference signal resources for a tracking reference signal (TRS) resource set toward a maximum number of active CSI reference signal resources.

21. The apparatus of claim 1, wherein the one or more processors are further configured to count a number of ports for a tracking reference signal (TRS) resource set toward a maximum number of ports.

22. A method of wireless communication performed by a user equipment (UE), comprising:
obtaining a channel state information (CSI) report that is associated with a multi-symbol downlink reference signal and that indicates a report quantity associated with a Doppler shift measurement, a per-path Doppler measurement, or a per-beam-per-path Doppler measurement: and
counting a number of CSI processing units (CPUs) for processing the CSI report based at least in part on the report quantity.

23. The method of claim 22, wherein the number of CPUs is a fixed number.

24. The method of claim 23, wherein the fixed number is based at least in part on a number of paths associated with the per-path Doppler measurement.

25. The method of claim 23, wherein the fixed number is based at least in part on a number of paths, a number of beams, or the number of paths and the number of beams associated with the per-beam-per-path Doppler measurement.

26. The method of claim 23, wherein the fixed number is based at least in part on a number of Doppler values associated with the per-path Doppler measurement or the per-beam-per-path Doppler measurement.

27. The method of claim 26, wherein the number of Doppler values is a number of Doppler frequencies associated with the per-path Doppler measurement or the per-beam-per-path Doppler measurement.

28. The method of claim 22, wherein counting the number of CPUs comprises using a first counting process if the report quantity is associated with the Doppler shift measurement or a second counting process if the report quantity is associated with the per-path Doppler measurement or the per-beam-per-path Doppler measurement.

29. The method of claim 22, wherein counting the number of CPUs comprises counting a number of CSI reference signal resources within a tracking reference signal burst.

30. The method of claim 22, wherein the multi-symbol downlink reference signal is a generic reference signal, a positioning reference signal, a tracking reference signal, a radar reference signal, or a CSI reference signal.
